(19) United States
(12) Patent Application Publication
(10) Pub. No.: US 2012/0110095 A1
(43) Pub. Date: May 3, 2012

(54) ACCURATELY ACCOUNT FOR TIME ZONE DIFFERENCES BETWEEN STOCK BROKERS AND CLIENTS IN REPLYING MESSAGING COMMUNICATION

(76) Inventor: YAT WAI EDWIN KWONG, Hong Kong (HK)

(21) Appl. No.: 12/938,787

(22) Filed: Nov. 3, 2010

(51) Int. Cl. G06F 15/16

(52) U.S. Cl. 709/206; 709/246

(57) ABSTRACT

Systems and methods are provided for accurately accounting for time zone differences in replying messages between stock brokers and clients. In accordance with one implementation, a system is provided that include an electronic messaging system comprising a processor, a memory, a client mobile device, and a broker mobile device. The system is further configured to record time-related information, including not only the time when received or sent the messaging communication, but also the time-zone information in communications between clients and brokers.

### BACKGROUND

I. Technical Field

The present invention generally relates to account for time-related information in communications between stock brokers and clients. Specifically, and without limitation, the invention relates to systems and methods that record time-related information, including not only the time when received or sent the messaging communication, but also the time-zone information in communications between clients and brokers.

II. Background Information

Using electronic messaging systems are becoming increasingly popular in electronic communications such as email messaging. Sometimes, the ability to accurately account for time zone differences in replying a number of messages between stock brokers and clients is crucial. It has been reported that many would question whether stock brokers can promptly take orders in response to instructions from their clients. As an example, when a stock broker sends pricing information with respect to a stock through mail messaging, the stock broker's intended client may want to accept the proposed pricing by returning a mail messaging. The problem is, when the broker fails to execute the client's order promptly, ultimate prices of the ordered stock will vary. Thus, it is very important for the broker to execute an order from his or her clients at a timely fashion. If any disputes arise, the client should be able to put forth evidence to demonstrate that the broker fails to execute the intended order instantly, which result in losses or other damages. This problem becomes even further complicated by the fact that the client and the broker may be located in different time zones. As such, any records from the conversations in the form of messaging communications between the client and the broker must be recorded with time-related information, including not only the time when received or sent the messaging communication, but also to provide clearly the time-zone information between the client and the broker.

In view of the foregoing, there is a need for systems and methods that can account for time-related information in communications between stock brokers and clients. There is also a need for systems and methods that can record not only the time when received or sent the messaging communication, but also the time-zone information in communications between clients and brokers.

### SUMMARY

Embodiments of the present invention relate to systems and methods for accurately accounting for time zone differences in replying messages between stock brokers and clients. Certain embodiments of the invention include an electronic messaging system comprising a processor, a memory, a client mobile device, and a broker mobile device. A client mobile device may be defined as a device representing a client, whereas a broker mobile device may be defined as a device representing a broker. The client mobile device and the broker mobile device may be a PDA, laptop, netbook, tablet, or anyone of the portable devices.

In accordance with all embodiments of the invention, a memory may be included that stores instructions causing the processor to perform a method. The method includes having a client to receive an incoming email from a mail incoming server sent by the client's broker through the broker mobile device. In response to the incoming email from the mail incoming server, the client may compose an outgoing email through the client mobile device, wherein the outgoing email includes the incoming email serving as a replying email; including, by the client through the client mobile device, outgoing time when the outgoing email is sent, wherein the outgoing time is represented in UTC format and included in an email header of the outgoing email. A SMTP server may be used to receive the outgoing email. Thereafter, an MTA server may be configured to receive the outgoing email from the SMTP server. The broker may subsequently receive the outgoing email from the MTA server, through the broker mobile device.

In one embodiment, when a client receives the incoming email from the mail incoming server, the email may be configured to include information related to price quotation of a stock. Further, the email includes incoming time of receiving the email from the incoming server. The incoming time may be represented multiple formats. Among many, one format is the UTC format.

Alternately, the email may include information related to sending time when the email is sent from a sender, so that not only the incoming time but also the sending time can be recorded, as consistent with embodiments of the present invention.

In another embodiment, an outgoing email may be composed by the client to accept the price quotation of the stock. In which case, the outgoing email would include the incoming email so that the incoming email can serve as a replying email to the original price quotation of the stock for confirmation.

In some cases, however, an embodiment may be included to counter offer with respect to the price quotation included in the incoming email from the mail incoming server. The client may want to compose an outgoing email through the client mobile device to counter with a new price quotation, wherein, similarly, the outgoing email would include the incoming email serving as a replied email to the original offer by the broker.

As stated above, the incoming time may be represented in multiple formats. One format is UTC. In one embodiment, after receiving the incoming email, the client may use the client mobile device to convert the incoming time from the UTC format to a non-UTC format, in accordance with time zone of the incoming server.

The time and time zone related information may be used to serve as time zone evidence in order to protect the client. Such information may include the incoming time represented in UTC format in the outgoing email. The incoming time may be included in the outgoing email as email body or email header before the outgoing email is sent to the broker.

In one alternate implementation, both the incoming time in the non-UTC format and information concerning time zone of the incoming server are included in the outgoing email. In another alternate implementation, only the sending time in the non-UTC format is included in the outgoing email. The information concerning the time zone of the incoming server into the outgoing email in which case would be omitted from the outgoing email. In yet another implementation, both the sending time in the UTC format and information concerning the time zone of the sender is included in the outgoing email. In which case, the sending time may be included in the outgoing email as email body or email header before the outgoing email is sent to the broker.

A SMTP server may be used to receive outgoing emails from the client. In one embodiment, the SMTP server may be configured to check if the email body of the outgoing email includes a replied message including the incoming time represented in UTC format. In another embodiment, the SMTP server may reject the outgoing email if both the sending time in the non-UTC format and information concerning the time zone of the sender into the outgoing email are absent from the outgoing email.

A MTA sever receives outgoing emails from the SMTP server. In one embodiment, the MTA server may be used to validate if both the sending time in the non-UTC format and information concerning the time zone of the sender into the outgoing email are included in the outgoing email.

When the broker receives an replying email from the client, the replying email may be used to serve as a third email between the broker and the client. In one embodiment, the replying email includes time zone information of each of the previous emails, from which these emails are communications between the broker and the client. Such information may be stored in a body of the replying email. Alternatively, the replying email may include the time zone information of each of the previous emails sent by the broker and the client in a body of the replying email.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating an exemplary system, consistent with an embodiment of the present invention.

### DETAILED DESCRIPTION

Embodiments of the present invention relate to systems and methods for to systems and methods for accurately accounting for time zone differences in replying messages between stock brokers 100 and clients 140. Certain embodiments of the invention include an electronic messaging system comprising a processor, a memory, a client mobile device, and a broker mobile device. A client mobile device may be defined as a device representing a client 140, whereas a broker mobile device may be defined as a device representing a broker 100. The client mobile device and the broker mobile device may be a PDA, laptop, netbook, tablet, or anyone of the portable devices.

Reference will now be made in detail to the present exemplary embodiments of the invention, examples of which are illustrated in the accompanying drawings. Wherever possible, the same reference numbers will be used throughout the drawings to refer to the same or like parts.

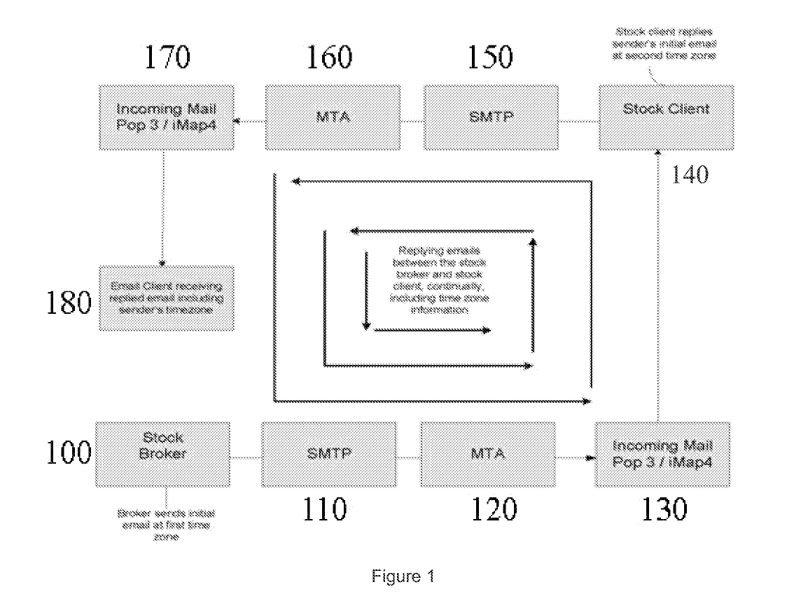

Referring to FIG. 1, an electronic messaging system is provided. The system is adapted to accurately account for time zone differences in replying messages between stock brokers 100 and clients 140. The system includes a processor; a client mobile device representing a client 140, including a PDA, laptop, netbook, or a tablet; a broker mobile device representing a broker 100, including a PDA, laptop, netbook, or a tablet; a memory storing instructions to cause the processor to perform a method. The method comprises receiving an incoming email, as a first email, from a mail incoming server 130 sent by the broker 100 through the broker mobile device, wherein the email includes information with respect to price quotation of a stock and incoming time of receiving the email from the incoming server 130, the incoming time represented in UTC format. In response to the incoming email from the mail incoming server 130, the client 140 may compose an outgoing email, as a second email, through the client mobile device to accept the price quotation of the stock, wherein the outgoing email includes the incoming email serving as a replying email. To serve as time zone evidence in order to protect the client 140, the client 140 may include, through the client mobile device, the incoming time represented in UTC format in the outgoing email, wherein the incoming time is included in the outgoing email as email body before the outgoing email is sent. The client 140 may, through the client mobile device, include outgoing time when the outgoing email is sent, wherein the outgoing time is represented in UTC format and included in an email header of the outgoing email. The method may further include receiving the outgoing email by an SMTP server 150, wherein the SMTP server 150 checks if the email body of the outgoing email includes a replied message including the incoming time represented in UTC format; receiving the outgoing email by an MTA server 160 from the SMTP server 150; receiving the outgoing email, from the MTA server 160, by the broker 100 through the broker mobile device; and replying an email by the broker 100 to the client 140, wherein the replying email serves as the third email between the broker 100 and the client 140, and the replying email includes time zone information of each of the previous emails, including the first email, second email, and the third email, which are communicated between the broker,100 and the client 140 in a body of the replying email.

In one implementation, an electronic messaging system may be provided to accurately account for time zone differences between stock brokers 100 and clients 140. The system may be configured to support receiving an incoming email from a mail incoming server 130 sent by the broker 100 through the broker mobile device, wherein the email includes information with respect to price quotation of a stock and incoming time of receiving the email from the incoming server 130, the incoming time represented in UTC format; to counter offer with respect to the price quotation included in the incoming email from the mail incoming server 130, composing an outgoing email by the client 140 through the client mobile device to counter with a new price quotation, wherein the outgoing email includes the incoming email serving as a replied email; converting, by the client 140 through the client mobile device, the incoming time from the UTC format to a non-UTC format, in accordance with time zone of the incoming server 130; to serve as time zone evidence in order in order to protect the client 140, including, by the client 140 through the client mobile device, both the incoming time in the non-UTC format and information concerning time zone of the incoming server 130, wherein the incoming time is included in the outgoing email as email body before the outgoing email is sent; including, by the client 140 through the client mobile device, outgoing time in the outgoing email when the outgoing email is sent, wherein the outgoing time is represented in UTC format and included in an email header of the outgoing email; receiving the outgoing email by an SMTP server 150; receiving the outgoing email by an MTA server 160 from the SMTP server 150; receiving the outgoing email, from the MTA server 160, by the broker 100 through the broker mobile device; and replying an email by the broker 100 to the client 140, wherein the replying email includes time zone information of each of the previous emails sent by the broker 100 and the client 140 in a body of the replying email.

In a further example, the electronic messaging system may be configured to perform receiving an incoming email from a mail incoming server 130 sent by the broker 100 through the broker mobile device, wherein the email includes information with respect to sending time when the email is sent from a sender, the sending time represented in UTC format; in response to the incoming email from the mail incoming server 130, composing an outgoing email by the client 140 through the client mobile device, wherein the outgoing email includes the incoming email serving as a replying email; converting, by the client 140 through the client mobile device, the sending time from the UTC format to a non-UTC format, in accordance with time zone of the sender; to serve as time zone evidence in order in order to protect the client 140, including, by the client 140 through the client mobile device, both the sending time in the non-UTC format and information concerning the time zone of the sender into the outgoing email, wherein the sending time is included in the outgoing email as email body before the outgoing email is sent; including, by the client 140 through the client mobile device, outgoing time in the outgoing email when the outgoing email is sent, wherein the outgoing time is represented in UTC format and included in an email header of the outgoing email; receiving the outgoing email by an SMTP server 150, wherein the SMTP server 150 rejects the outgoing email if both the sending time in the non-UTC format and information concerning the time zone of the sender into the outgoing email are absent from the outgoing email; receiving the outgoing email by an MTA server 160 from the SMTP server 150; and receiving the outgoing email, from the MTA server 160, by the broker 100 through the broker mobile device.

Further, the system may alternatively be configured to support receiving an incoming email from a mail incoming server 130 sent by the broker 100 through the broker mobile device, wherein the email includes information with respect to sending time when the email is sent from the broker 100 though the broker mobile device, the sending time represented in UTC format; in response to the incoming email from the mail incoming server 130, composing an outgoing email after receiving the incoming email, wherein the outgoing email includes the incoming email serving as a replied email; converting, by the client 140 through the client mobile device, the sending time from the UTC format to a non-UTC format, in accordance with time zone of the incoming server 130; to serve as time zone evidence in order in order to protect the client 140, including, by the client 140 through the client mobile device, both the sending time in the non-UTC format and information concerning the time zone of the incoming server 130 into the outgoing email, wherein the sending time is included in the outgoing email as email body before the outgoing email is sent; and including, by the client 140 through the client mobile device, outgoing time in the outgoing email when the outgoing email is sent, wherein the outgoing time is represented in UTC format and included in an email header of the outgoing email; receiving the outgoing email by an SMTP server 150; receiving the outgoing email by an MTA server 160 from the SMTP server 150; and receiving the outgoing email, from the MTA server 160, by the broker 100 through the broker mobile device.

Even further the inventive system may be configured to perform receiving, by an email client serving as part of the electronic messaging system, an incoming email from a mail incoming server 130, wherein the email includes information with respect to sending time when the email is sent from the broker 100 through the broker mobile device, the sending time represented in UTC format; in response to the incoming email from the mail incoming server 130, composing an outgoing email after receiving the incoming email, wherein the outgoing email includes the incoming email serving as a replied email; converting, by the client 140 through the client mobile device, the sending time from the UTC format to a non-UTC format, in accordance with time zone of the incoming server 130; to serve as time zone evidence in order in order to protect the client 140, including, by the client 140 through the client mobile device, only the sending time in the non-UTC format without including information concerning the time zone of the incoming server 130 into the outgoing email, wherein the sending time is included in the outgoing email as email body before the outgoing email is sent; and including, by the client 140 through the client mobile device, the outgoing time in the outgoing email when the outgoing email is sent, wherein the outgoing time is represented in UTC format and included in an email header of the outgoing email.

Moreover, the inventive system may be configured to perform receiving an incoming email from a mail incoming server 130 sent by the broker 100 through the broker mobile device, wherein the email includes information with respect to sending time when the email is sent from a sender, the sending time represented in UTC format; in response to the incoming email from the mail incoming server 130, composing an outgoing email after receiving the incoming email, wherein the outgoing email includes the incoming email serving as a replied email; to serve as time zone evidence in order in order to protect the client 140, including, by the client 140 through the client mobile device, both the sending time in the UTC format and information concerning the time zone of the sender into the outgoing email, wherein the sending time is included in the outgoing email as email body before the outgoing email is sent; and including, by the client 140 through the client mobile device, the outgoing time in the outgoing email when the outgoing email is sent, wherein the outgoing time is represented in UTC format and included in an email header of the outgoing email; receiving the outgoing email by an SMTP server 150; receiving the outgoing email by an MTA server 160 from the SMTP server 150; and receiving the outgoing email, from the MTA server 160, by the broker 100 through the broker mobile device.

In a next implementation, the system is adapted to support receiving an incoming email from a mail incoming server 130 sent by the broker 100 through the broker mobile device, wherein the email includes information with respect to incoming time of receiving the email from the incoming server 130, the incoming time represented in UTC format; in response to the incoming email from the mail incoming server 130, composing an outgoing email, wherein the outgoing email includes the incoming email serving as a replied email; to serve as time zone evidence in order in order to protect the client 140, including, by the client 140 through the client mobile device, the incoming time represented in UTC format in the outgoing email, wherein the incoming time is included in the outgoing email as email header before the outgoing email is sent; and including, by the client 140 through the client mobile device, outgoing time when the outgoing email is sent, wherein the outgoing time is represented in UTC format and included in an email header of the outgoing email;

In another example, the system may be used to perform converting, by the client 140 through the client mobile device, the incoming time from the UTC format to a non-UTC format, in accordance with time zone of the incoming server 130; to serve as time zone evidence in order in order to protect the client 140, including, by the client 140 through the client mobile device, both the incoming time in the non-UTC format and information concerning time zone of the incoming server 130, wherein the incoming time is included in the outgoing email as email header before the outgoing email is sent; and including, by the client 140 through the client mobile device, the outgoing time in the outgoing email when the outgoing email is sent, wherein the outgoing time is represented in UTC format and included in an email header of the outgoing email; receiving the outgoing email by an SMTP server 150; receiving the outgoing email by an MTA server 160 from the SMTP server 150; and receiving the outgoing email, from the MTA server 160, by the broker 100 through the broker mobile device.

As another example, the system may support receiving an incoming email from a mail incoming server 130 sent by the broker 100 through the broker mobile device, wherein the email includes information with respect to sending time when the email is sent from a sender, the sending time represented in UTC format; in response to the incoming email from the mail incoming server 130, composing an outgoing email after receiving the incoming email, wherein the outgoing email includes the incoming email serving as a replied email; converting, by the client 140 through the client mobile device, the sending time from the UTC format to a non-UTC format, in accordance with time zone of the sender; to serve as time zone evidence in order in order to protect the client 140, including, by the client 140 through the client mobile device, both the sending time in the non-UTC format and information concerning the time zone of the sender into the outgoing email, wherein the sending time is included in the outgoing email as email header before the outgoing email is sent; and including, by the client 140 through the client mobile device, the outgoing time in the outgoing email when the outgoing email is sent, wherein the outgoing time is represented in UTC format and included in an email header of the outgoing email; receiving the outgoing email by an SMTP server 150; receiving the outgoing email by an MTA server 160 from the SMTP server 150, wherein the MTA server 160 validates if both the sending time in the non-UTC format and information concerning the time zone of the sender into the outgoing email are included in the outgoing email; and receiving the outgoing email, from the MTA server 160, by the broker 100 through the broker mobile device.

The next implementation may support receiving an incoming email from a mail incoming server 130 sent by the broker 100 through the broker mobile device, wherein the email includes information with respect to sending time when the email is sent from a sender, the sending time represented in UTC format; in response to the incoming email from the mail incoming server 130, composing an outgoing email after receiving the incoming email, wherein the outgoing email includes the incoming email serving as a replied email; converting, by the client 140 through the client mobile device, the sending time from the UTC format to a non-UTC format, in accordance with time zone of the incoming server 130; to serve as time zone evidence in order in order to protect the client 140, including, by the client 140 through the client mobile device, both the sending time in the non-UTC format and information concerning the time zone of the incoming server 130 into the outgoing email, wherein the sending time is included in the outgoing email as email header before the outgoing email is sent; and including, by the client 140 through the client mobile device, the outgoing time in the outgoing email when the outgoing email is sent, wherein the outgoing time is represented in UTC format and included in an email header of the outgoing email; receiving the outgoing email by an SMTP server 150; receiving the outgoing email by an MTA server 160 from the SMTP server 150; and receiving the outgoing email, from the MTA server 160, by the broker 100 through the broker mobile device.

Another embodiment includes support receiving an incoming email from a mail incoming server 130 sent by the broker 100 through the broker mobile device, wherein the email includes information with respect to sending time when the email is sent from a sender, the sending time represented in UTC format; in response to the incoming email from the mail incoming server 130, composing an outgoing email after receiving the incoming email, wherein the outgoing email includes the incoming email serving as a replied email; converting, by the client 140 through the client mobile device, the sending time from the UTC format to a non-UTC format, in accordance with time zone of the incoming server 130; to serve as time zone evidence in order in order to protect the client 140, including, by the client 140 through the client mobile device, only the sending time in the non-UTC format without including information concerning the time zone of the incoming server 130 into the outgoing email, wherein the sending time is included in the outgoing email as email header before the outgoing email is sent; and including, by the client 140 through the client mobile device, the outgoing time in the outgoing email when the outgoing email is sent, wherein the outgoing time is represented in UTC format and included in an email header of the outgoing email; receiving the outgoing email by an SMTP server 150; receiving the outgoing email by an MTA server 160 from the SMTP server 150; and receiving the outgoing email, from the MTA server 160, by the broker 100 through the broker mobile device.

In a next alternate example, the inventive system supports receiving an incoming email from a mail incoming server 130 sent by the broker 100 through the broker mobile device, wherein the email includes information with respect to sending time when the email is sent from a sender, the sending time represented in UTC format; in response to the incoming email from the mail incoming server 130, composing an outgoing email after receiving the incoming email, wherein the outgoing email includes the incoming email serving as a replied email; to serve as time zone evidence in order in order to protect the client 140, including, by the client 140 through the client mobile device, both the sending time in the UTC format and information concerning the time zone of the sender into the outgoing email, wherein the sending time is included in the outgoing email as email header before the outgoing email is sent; and including, by the client 140 through the client mobile device, the outgoing time in the outgoing email when the outgoing email is sent, wherein the outgoing time is represented in UTC format and included in an email header of the outgoing email; receiving the outgoing email by an SMTP server; receiving the outgoing email by an MTA server 160 from the SMTP server 150; and receiving the outgoing email, from the MTA server 160, by the broker 100 through the broker mobile device.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. An electronic messaging system to accurately account for time zone differences in replying messages between stock brokers and clients, comprising:
a processor;
a client mobile device representing a client;
a broker mobile device representing a broker;
a memory storing instructions to cause the processor to perform a method, comprising
receiving an incoming email from a mail incoming server sent by the broker through the broker mobile device;
in response to the incoming email from the mail incoming server, composing an outgoing email, by the client through the client mobile device, wherein the outgoing email includes the incoming email serving as a replying email;
including, by the client through the client mobile device, outgoing time when the outgoing email is sent, wherein the outgoing time is represented in UTC format and included in an email header of the outgoing email;
receiving the outgoing email by an SMTP server;
receiving the outgoing email by an MTP server from the SMTP server; and
receiving the outgoing email, from the MTP server, by the broker through the broker mobile device.

2. The system of claim 1, wherein
the outgoing email is composed to counter offer with respect to a price quotation included in the incoming email from the mail incoming server; and
the method further comprises:
converting, by the client through the client mobile device, the incoming time from the UTC format to a non-UTC format, in accordance with time zone of the incoming server;
to serve as time zone evidence in order in order to protect the client, including, by the client through the client mobile device, both the incoming time in the non-UTC format and information concerning time zone of the incoming server, wherein the incoming time is included in the outgoing email as email body before the outgoing email is sent; and
replying an email by the broker to the client, wherein the replying email includes time zone information of each of the previous emails sent by the broker and the client in a body of the replying email.

3. The system of claim 1, wherein
the incoming email includes information with respect to sending time when the email is sent from a sender, the sending time represented in UTC format; and
the method further comprises:
converting, by the client through the client mobile device, the incoming time from the UTC format to a non-UTC format, in accordance with time zone of the incoming server;
to serve as time zone evidence in order to protect the client, including, by the client through the client mobile device, both the incoming time in the non-UTC format and information concerning time zone of the incoming server in the outgoing email; and
rejecting the outgoing email by the SMTP server if both the sending time in the non-UTC format and information concerning the time zone of the sender into the outgoing email are absent from the outgoing email.

4. The system of claim 1, wherein
the incoming email includes information with respect to sending time when the email is sent from the broker through the broker mobile device, the sending time represented in UTC format; and
the method further comprises
converting, by the client through the client mobile device, the incoming time from the UTC format to a non-UTC format, in accordance with time zone of the incoming server; and
to serve as time zone evidence in order to protect the client, including, by the client through the client mobile device, both the incoming time in the non-UTC format and information concerning time zone of the incoming server.

5. The system of claim 1, wherein
the incoming email includes information with respect to sending time when the email is sent from the broker through the broker mobile device, the sending time represented in UTC format; and
the method further comprises:
converting, by the client through the client mobile device, the incoming time from the UTC format to a non-UTC format, in accordance with time zone of the incoming server; and
to serve as time zone evidence in order to protect the client, including, by the client through the client mobile device, only the sending time in the non-UTC format without including information concerning the time zone of the incoming server into the outgoing email.

6. The system of claim 1, wherein
the incoming email includes information with respect to sending time when the email is sent from a sender, the sending time represented in UTC format; and
the method further comprises:
to serve as time zone evidence in order to protect the client, including, by the client through the client mobile device, both the sending time in the UTC format and information concerning the time zone of the sender into the outgoing email.

7. The system of claim 1, wherein
the incoming email includes information with respect to price quotation of a stock and incoming time of receiving the email from the incoming server, the incoming time represented in UTC format; and
the method further comprises:
to serve as time zone evidence in order to protect the client, including, by the client through the client mobile device, wherein the incoming time is included in the outgoing email as email header before the outgoing email is sent.

8. The system of claim 1, wherein
the method further comprises:
to serve as time zone evidence in order to protect the client, including, by the client through the client mobile device, wherein the incoming time is included in the outgoing email as email header before the outgoing email is sent; and
converting, by the client through the client mobile device, the incoming time from the UTC format to a non-UTC format, in accordance with time zone of the incoming server.

9. The system of claim 1, wherein
the method further comprises:
to serve as time zone evidence in order to protect the client, including, by the client through the client mobile device, wherein the incoming time is included in the outgoing email as email header before the outgoing email is sent; and
converting, by the client through the client mobile device, the incoming time from the UTC format to a non-UTC format, in accordance with time zone of the incoming server; and
the MTP server validates if both the sending time in the non-UTC format and information concerning the time zone of the sender into the outgoing email are included in the outgoing email.

10. An electronic messaging system to accurately account for time zone differences in replying messages between stock brokers and clients, comprising:
a processor;
a client mobile device representing a client, including a PDA, laptop, netbook, or a tablet;
a broker mobile device representing a broker, including a PDA, laptop, netbook, or a tablet;
a memory storing instructions to cause the processor to perform a method, comprising
receiving an incoming email, as a first email, from a mail incoming server sent by the broker through the broker mobile device, wherein the email includes information with respect to price quotation of a stock and incoming time of receiving the email from the incoming server, the incoming time represented in UTC format;
in response to the incoming email from the mail incoming server, composing an outgoing email as a second email, by the client through the client mobile device to accept the price quotation of the stock, wherein the outgoing email includes the incoming email serving as a replying email;
to serve as time zone evidence in order to protect the client, including, by the client through the client mobile device, the incoming time represented in UTC format in the outgoing email, wherein the incoming time is included in the outgoing email as email body before the outgoing email is sent;
including, by the client through the client mobile device, outgoing time when the outgoing email is sent, wherein the outgoing time is represented in UTC format and included in an email header of the outgoing email;
receiving the outgoing email by an SMTP server, wherein the SMTP server checks if the email body of the outgoing email includes a replied message including the incoming time represented in UTC format;
receiving the outgoing email by an MTP server from the SMTP server;
receiving the outgoing email, from the MTP server, by the broker through the broker mobile device; and
replying an email by the broker to the client, wherein the replying email serves as the third email between the broker and the client, and the replying email includes time zone information of each of the previous emails, including the first email, second email, and the third email, which are communicated between the broker and the client in a body of the replying email.

11. An electronic messaging system to accurately account for time zone differences between stock brokers and clients, comprising:
a processor;
a client mobile device representing a client, including a PDA, laptop, netbook, or a tablet;
a broker mobile device representing a broker, including a PDA, laptop, netbook, or a tablet; and
a memory storing instructions to cause the processor to perform a method, comprising
receiving an incoming email from a mail incoming server sent by the broker through the broker mobile device, wherein the email includes information with respect to sending time when the email is sent from a sender, the sending time represented in UTC format;
in response to the incoming email from the mail incoming server, composing an outgoing email after receiving the incoming email, wherein the outgoing email includes the incoming email serving as a replied email;
converting, by the client through the client mobile device, the sending time from the UTC format to a non-UTC format, in accordance with time zone of the incoming server;
to serve as time zone evidence in order in order to protect the client, including, by the client through the client mobile device, only the sending time in the non-UTC format without including information concerning the time zone of the incoming server into the outgoing email, wherein the sending time is included in the outgoing email as email header before the outgoing email is sent;
including, by the client through the client mobile device, the outgoing time in the outgoing email when the outgoing email is sent, wherein the outgoing time is represented in UTC format and included in an email header of the outgoing email;
receiving the outgoing email by an SMTP server;
receiving the outgoing email by an MTP server from the SMTP server; and
receiving the outgoing email, from the MTP server, by the broker through the broker mobile device.

12. The system of claim 1, wherein
the method further comprises:
in response to the incoming email from the mail incoming server, composing an outgoing email by the client through the client mobile device, wherein the outgoing email includes the incoming email serving as a replying email; and
to serve as time zone evidence in order to protect the client, including, by the client through the client mobile device, wherein the incoming time is included in the outgoing email as email header before the outgoing email is sent; and
the SMTP server checks if the email body of the outgoing email includes a replied message including the incoming time represented in UTC format.
